(19) United States
(12) Patent Application Publication
(10) Pub. No.: US 2010/0025567 A1
(43) Pub. Date: Feb. 4, 2010

(54) Apparatus for imaging single molecules

(76) Inventor: Dietrich Wilhelm Karl Lueerssen, Oxford (GB)

Correspondence Address: WENDEROTH, LIND & PONACK, L.L.P., 1030 15th Street, N.W.,, Suite 400 East, Washington, DC, 20005-1503, US

(21) Appl. No.: 12/310,887

(22) PCT Filed: Sep. 14, 2007
(86) PCT No.: PCT/GB2007/003506

§ 371 Date: Jun. 23, 2009

(30) Foreign Application Priority Data
Sep. 14, 2006 (GB) 0618131.7
Sep. 14, 2006 (GB) 0618133.3
Jan. 11, 2007 (GB) 0700561.4

(51) Int. Cl. G01N 21/64; G02B 21/02; G02B 21/26

(52) U.S. Cl. 250/205; 359/368; 250/458.1; 359/383; 359/393; 359/392

(57) ABSTRACT

The present invention relates to apparatus for the imaging of single molecules.

All documents and on-line information cited herein are incorporated by reference in their entirety.

### TECHNICAL FIELD

The present invention relates to apparatus for the imaging of single molecules.

### BACKGROUND ART

Imaging apparatus and methods are used worldwide to obtain images of a sample which is to be analysed. This is often done by focusing on small areas of the sample and combining images of these small areas to obtain a single detailed image of the whole or a larger part of the sample. Some of these imaging techniques use single dye molecule spectroscopy, single quantum dot spectroscopy, and related types of ultra-sensitive microscopy and spectroscopy. However, there are few approaches that apply these techniques to microarray analysis.

Microarray experiments generally involve fluorescent microscopy of a sample that adheres to the surface of a microscope slide. There are different types of experimental designs, and the most common method images the emission of two spectrally distinct dyes (e.g., Cy3 and Cy5, emitting around 570 nm and 670 nm, respectively); Most commercial scanners are based on single-point detection, although increasingly there are also CCD-based systems. The typical linear pixel resolution is about 5-10 μm. Most known commercial microarray scanners are operated in essentially an analogue reading mode, even though the data is digitally stored (16 bit TIFF files are the norm) and processed. This is because it is only the intensity of the signal that is interpreted, e.g., intensities between experiments carried out on the same microscope slide are compared.

However, it is possible, using high-resolution optics and low densities of fluorescent molecules, to spatially discriminate and image single molecules, in which case these individual molecules can be counted. This comprises an entirely digital method, and enables comparison between different slides on an absolute basis. This methodology can extend to the case when molecules agglomerate, since apart from possible offset counts of the CCD (dark count, configured offsets, etc.), one molecule may result in a particular CCD count, whilst two molecules may result in a count of double that of one molecule. One of the key experimental considerations of single molecule spectroscopy is the use of a high spatial resolution, approaching the diffraction limit or even exceeding it. Techniques currently used to increase the spatial resolution include wide-field microscope optics, conventional as well as specialised confocal microscopy (e.g., 4PI, and stimulated emission depletion microscopy), scanning near-field optical microscopy (SNOM or NSOM), a method that uses a new Fundamental Resolution Measure (FREM) that is not the Rayleigh criterion (PNAS, Mar. 21, 2006, vol. 103 No. 12 4457-4462), and Photoactivated Localization Microscopy (PALM, Science Express online publication, 10 Aug. 2006).

Wide-field, as opposed to single-point, scanning systems generally acquire sequential images in order to cover large areas. In practice this corresponds to a sequence of sample positioning, auto-focusing, sample illumination, signal detection and CCD readout. A number of documents identify that this process, often called image tiling has severe drawbacks, in particular in limiting the maximum speed possible. For example, see U.S. Pat. No. 6,711,283 B1, Fully automated rapid slide scanner, and Sonnleitner et at, Proc. SPIE 5699 (2005): 202-210, High-Throughput Scanning with Single Molecule Sensitivity which mention that the mechanical motion of the sample positioning stage is the rate-limiting factor. A rough estimation of scanning times for comparable properties of the scan result (1 cm² with single-molecule sensitivity and pixel resolution better than 350 nm) have been reported as 3.8 months for single-point detection methods, about 10 hours for image tiling methods, and about 20 minutes using the method described in Sonnleitner et al., Proc. SPIE 5699 (2005): 202-210.

The need for an accurate automatic focusing system is mainly due to the small depth of field (DOF) associated with high-numerical aperture (NA) microscope objectives that are essential for high spatial resolution as well as good light harvesting. The accuracy requirement of the automatic focus mechanism is set by the NA of the microscope objective, the physical pixel size of the CCD, and the magnification of the microscope objective, i.e.

$$DOF = \frac{λ}{{NA}^{2}} + \frac{D}{NA \cdot M}$$

where D is the linear pixel dimension of the CCD, M is the magnification, and λ is the wavelength of light being imaged. As an example, a depth of field of 800 nm cannot be maintained over the entire microscope slide without focus adjustments for each image since the microscope slide is not flat enough over its entire area; small tilt angles can cause a sample movement parallel to the optical axis which results in an out-of-focus image.

U.S. Pat. No. 6,255,048 discloses a scanner developed to detect single molecules using biotinylated probes and fluoroassays. WO 00/06770 discloses single molecule detection for sequencing applications. Two companies that use single molecule imaging for sequencing applications are Solexa and Helicos. Solexa's approach is that single biomolecules are amplified on the same spot, and thus the amount of fluorescent label is multiple dye molecules. Helicos, on the other hand, uses imaging of single dye molecules in their approach. According to U.S. Pat. No. 7,169,560, each field of view (120 μm×60 μm) is imaged 8 times, with an exposure time of 0.5 seconds each. With this method, imaging an area of 1 cm2 takes 15 hours, taking into account the illumination time alone, and neglecting the time of any overheads such as positioning, image transfer, etc. These approaches image the fluorescent molecules in a liquid phase. In addition, they use immersion optics. This, as discussed below, is not desirable for the use in a microarray scanner.

An instrument exists which can be used as a microarray scanner with a high spatial resolution. The scanner is capable of rapidly resolving single dye molecules. The scanner is called the CytoScout™, and is made by Upper Austrian Research (UAR), based in Linz, Austria. The original purpose of the CytoScout™ is single live-cell imaging in 3D or 4D. However, the CytoScout™ has a number of weaknesses, technical and otherwise, when it is used as a microarray scanner.

In particular, the CytoScout™ includes an oil-immersion lens as the essential optical component. This has serious consequences. Firstly, the instrument requires a skilled operator for the application of the immersion oil. Secondly, in order to use oil-immersion optics it is necessary to cover a conventional microarray with a cover slip or to use a special type of microarray support that requires a coverslip instead of the conventionally used microscope slide. However, covering a microarray with a coverslip potentially damages the array. This means that standard microarray platforms cannot be used with this instrument. Hesse et al. state in Genome Research 16:1041-1045 (2006): “In conventional DNA microarray readout, the sensitivity is limited by standard formats of biochip substrates. Their thickness of ˜1 mm requires the implementation of imaging optics with a long working distance, at the expense of detection efficiency. Moreover, impurities within the substrate material typically generate a strong fluorescence background, which impedes ultrasensitive fluorescence detection on such biochips.” With regard to the conditions need for single molecule detection, Hesse et al. state that “To enable imaging at high-detection efficiency, DNA microarrays were established on the basis of 150-μm thick aldehyde-functionalized glass coverslips, which were selected for low autofluorescence (Schlapak et al. 2005).” It is evident from these statements that researchers have identified a problem with the CytoScout™ (namely that standard microarray slides cannot be scanned with high detection efficiency). However, the provided solution introduces new practical problems for users for example, inter alia, the use of fragile chips, and the need to change the manufacturing process.

Nevertheless, the use of oil-immersion optics provides a number of additional advantages. In particular, a numerical aperture of greater than one is possible; a higher numerical aperture results in smaller diffraction limited spots, allowing the spatial separation of single molecules from each other more easily. The use of oil-immersion optics also means that Total Internal Reflectance Fluorescence (TIRF) is possible. TIRF can be used to reduce the background of the excitation over the fluorescence which can lead to a better signal-to-noise ratio. In addition, dye molecules start to bleach when they are struck by free radicals such as oxygen in air. Consequently, if the dye molecules are exposed to air, they are unstable and the number of photons emitted is reduced. By covering a microarray with, for example, a cover slip, the number of such free radicals which can react with the dye molecules is reduced and the number of photons which can be detected is maximised. Consequently, single molecule imaging greatly benefits from the advantages of oil-immersion optics and, therefore, it was previously thought that immersion optics, such as those present in the CytoScout™, were necessary to make such single molecule imaging experiments possible.

An improved single molecule scanner is needed which overcomes the disadvantages of the CytoScout™ without losing its advantages.

### DISCLOSURE OF THE INVENTION

In view of the problems with known scanners discussed above, the present applicant has developed an improved single molecule scanner. FIG. 1 shows the components of an exemplary new scanner. The Single Molecule Scanner is essentially a microscope with the purpose of imaging large areas (e.g. 1 cm²) at an outstanding spatial resolution (e.g., 400 nm diffraction-limited resolution at 130 nm pixel resolution). The applicant's improved scanner may use some typical design features present in most state-of-the-art microscopes. However, their interplay is finely tuned and the scanner incorporates several additional features which are not known from the prior art. An optical path of an exemplary scanner is shown in FIG. 2.

In particular, a first aspect of the present invention provides a scanner for imaging single molecules and having a magnification, comprising:
a dry microscope objective defining an optical axis and having a numerical aperture of greater than or equal to 0.4.

Imaging of single molecules means detecting single molecules which are resolved from one another, rather than revealing the specific shape of the single molecules or exciting them. Resolving molecules from one another can be by means of spatial distinction, intensity discrimination, or other means.

A minimum NA of 0.4 is important to the resolution of the optical system. For wavelengths around 570 nm (Cy3 emission), and with NA=0.4, the diffraction limit (Sparrow criterion) is about 725 nm; this is considered to be the maximum for single molecule detection.

The scanner may further comprise:
a sample holder for holding a sample on the optical axis;
a focusing mechanism for adjusting the relative position of the sample and an optical plane of the scanner so that the sample is positioned in the focal plane of the scanner;
a light source for emitting an excitation beam and exciting one or more constituents of the sample to emit a fluorescent emission;
an optical element for separating the excitation beam from the fluorescent emission from the sample;
a detector for detecting the fluorescent emission from the sample, and having a plurality of pixel elements, wherein the linear dimension of each pixel element divided by the magnification of the scanner is smaller than the diffraction limited resolution of the microscope objective for visible light; and
a control unit configured to control one or more elements of the detector, the focusing mechanism, and the light source.

The typically used Rayleigh criterion for diffraction limited resolution states that the resolvable distance between two objects is d=0.61λ/NA. The Sparrow criterion yields d=0.47λ/NA. These two criteria do not represent absolute limits on the resolution of an optical system, as discussed in a commentary by Michalet and Weiss (PNAS, Mar. 28, 2006, vol. 103, no. 13, 4797-4798). However, both the Rayleigh and the Sparrow criterion have proven useful for rule-of-thumb estimates.

The sample may comprise cells which exhibit auto-fluorescence. Alternatively, the sample may be dyed or labelled with additional fluorescent molecules. For example, the sample may comprise a fluorescently labelled microarray. The sample may contain fluorescent molecules or particles. Examples of such fluorescent molecules or particles are:
organic dyes such as Cy3, Cy5, Alexa Fluors, etc.;
dye molecules linked to biopolymers;
inorganic dyes, for example quantum dot labels such as CdSe quantum dots, II-VI quantum dots, III-V quantum dots, etc;
intercalating dyes such as Ethidium Bromide, Hoechst dyes, etc.;
fluorescent microbeads, fluorescent microspheres, etc.; or
modified fluorescent particles such as amine-modified dyes, labelled nucleic acids, conjugated quantum dots, streptavidin-conjugated quantum dots, reactive quantum dots, etc.

The scanner of the invention is suitable for the detection of individual/single molecules in a variety of different samples including, but not limited to, microarrays for analysing DNA, protein or any other single category of biomolecule, tools that rely on analysing cell-free extracts, and tools based on microfluidic principles, for example, samples of the type disclosed in U.K. patent application 0625595.4 entitled “Sample Analyser”. For the purpose of this document, we define this class of sample as bioanalysis sample.

When the sample comprises cells, an alternative illumination method may be transmission of white or coloured light through the sample towards the microscope optics, rather than the co-axial illumination from the microscope objective towards the sample, which is advantageously used for excitation-emission imaging. While this method is generally not implemented in microarray scanners, it is commonly used for cell biological applications. The light source may be incorporated into the sample holding mechanism, or it may be independent of it. When the sample comprises cells, use of the invention may involve the types of analyses described in co-pending United Kingdom patent application no. 0625595.4 filed on 21st Dec. 2006 by the present applicant and entitled “Sample Analyser” (Attorney's ref: P045675GB).

The use of a dry microscope objective, corrected for a cover slip thickness of zero, means that neither the use of immersion liquid nor the use of cover slips is required, and the sample is less likely to be damaged.

The numerical aperture of the microscope objective is greater than 0.4, preferably greater than 0.6 and more preferably greater than 0.8. The ranges of NA are preferably 0.4<NA<1, and more preferably 0.6<NA≦1. In a preferred embodiment the microscope objective has a numerical aperture of 0.95. The Nyquist criterion states that in order to resolve a distance d, a distance of at least d/2 must be sampled. When NA=0.95, the Sparrow criterion gives the optical resolution as 280 nm, requiring a pixel resolution of less than 140 nm. Therefore, preferably a detector with an effective pixel element of less than 140 nm is used.

The magnification of the scanner is preferably provided by the microscope objective. Preferably the objective lens is an infinity-corrected lens, in which case, the magnification of the scanner is provided by the microscope objective in combination with a tube lens. The optics is optimised (and the nominal magnification of the objective lens is chosen) for the focal length of the selected tube lens. Selection of a tube lens with a different focal length yields a different magnification; the magnification is directly proportional to the focal length of the tube lens. In a preferred embodiment, the magnification of the microscope objective is 50×. The preferred magnification is dependent on the pixel element size of the detector employed. The diffraction limit, d, limits the optical resolution, and the Nyquist criterion dictates that that pixel size has to be at the most half of this size in order to resolve features of the size of the diffraction limit. The pixel resolution is given by a combination of the CCD pixel size, and the lateral magnification of the imaging size as follows:

$$d = \frac{α λ}{NA}$$

where either α=0.61 for the Rayleigh criterion or α=0.47 for the Sparrow criterion, λ is the wavelength of light, NA is the numerical aperture of the optics;

p<β.d where p is the effective pixel size. This is the Nyquist criterion: the effective pixel size has to be smaller than a fraction, β, of the length one wants to resolve;

$$p = \frac{L}{M} ,$$

i.e. the effective pixel size, p, depends on the physical pixel size, L, (linear dimension) of the detector and the lateral magnification, M, of the microscope optics. Therefore,

$$\frac{L}{M} < β \frac{α . λ}{NA} .$$

The parameter, β, is chosen to be 0.1<β<2 and preferably 0.3<β<1.

For example, with a CCD having a pixel size of 6.45 μm, using an objective with NA=0.95, and light with wavelength of 570 nm, the Sparrow criterion gives an optical resolution of 280 nm, the Nyquist criterion gives a pixel resolution of <140 nm. Therefore, the required magnification is of the order of 50×. Preferably the magnification of the scanner is between 40× and 100×. As the pixel size decreases by a factor f, the scanning speed of the instrument decreases by a factor of f² since the scanning speed is proportional to the total area that is being imaged.

The focal plane of the scanner may coincide with the focal plane of the microscope objective. Alternatively, the focal plane of the scanner may not coincide with the focal plane of the microscope objective.

The detector is preferably a charged coupled device (CCD), more preferably a cooled CCD and, even more preferably, a peltier-cooled CCD. Alternatively, a CMOS detector, an electron-multiplying CCD or an intensified CCD could be used.

Preferably, the dark count and the noise level for selected exposure details of the detector are such that the emission from at least one fluorescent molecule or particle can be distinguished from a background. The measured signal from a CCD imaging system, utilized in calculating the signal-to-noise ratio, is proportional to the photon flux incident on the CCD photodiodes (expressed as photons per pixel per second), the quantum efficiency of the device (where 1 represents 100 percent efficiency), and the integration time (exposure time) over which the signal is collected. The signal is also dependent on the electronics of the camera, which includes but is not limited to the gain stage and the analogue to digital converter. Three primary undesirable signal components (noise) are typically considered in calculating overall signal-to-noise ratios: photon noise resulting from the inherent statistical variation in the arrival rate of photons incident on the CCD and equivalent to the square-root of the signal, dark noise arising from statistical variation in the number of electrons thermally generated within the structure of the CCD, and read noise inherent to the process of converting CCD charge carriers into a voltage signal for quantification, and the subsequent processing and analog-to-digital conversion. The signal-to-noise ratio can be improved by cooling the CCD during the acquisition of the images. Post-acquisition image processing techniques such as local background reduction, thresholding based on the knowledge of the emission intensity and the spatial profile of a single molecule, etc., as well as counting of individual molecules potentially get rid of noise almost completely. For example, see Muresan et al., IEEE International Conference on Image Processing, 11-14 Sep. 2005. Volume 2:1274-1277; and Hesse et al., Genome Research 16:1041-1045 (2006).

The scanner may further comprise a translation stage moveable in at least two directions which are in a plane substantially perpendicular to the optical axis, wherein the sample holder is mounted on the translation stage.

The translation stage may be provided with tilt-adjustment in order to ensure the sample is positioned substantially perpendicular to the optical axis.

Furthermore, the translation stage may be movable in a direction substantially parallel to the optical axis. Alternatively, or additionally, the objective lens may be movable in a direction substantially parallel to the optical axis. In the case of infinity-corrected optics, it is preferable to move the objective lens rather than the translation stage along the optical axis because the movable mass is typically smaller, making the translation step easier and faster.

Preferably the translation stage provides position information to the control unit. Preferably the position information has a resolution comparable or better than the linear pixel dimension of the detector divided by the magnification of the microscope objective. More preferably, the speed of the translation stage is such that a scheduling mechanism as described in United Kingdom Patent Application No. 0618133.3, which is herein incorporated by reference, can be implemented. For example, the translation stage is capable of being moved at a speed such that the stage can be moved into a position in which a second area of the sample is imaged, at the same time as image data obtained for a first area of the sample is being transferred to memory. Preferably, during the time it takes to transfer the image data obtained for the first area to memory, the scanner is focused so that the sample is in the focal plane of the scanner. Preferably, the time taken for one step-and-settle operation is <30 ms, and more preferably <20 ms.

Preferably, the sample holder provides a reference surface, against which the test surface that is to be imaged is pressed. Consequently, wedge angles between the front and back surface of the sample, or sample thickness variations over the total area of the sample, where the sample is, e.g. a microscope slide with a microarray on one side, will not affect the tilt of the sample with respect to the optical axis. An appropriate sample holding mechanism is shown in FIG. 9.

The test surface may be positioned to face the scanner optics. Alternatively, the test surface may be arranged on a surface of a microscope slide facing away from the scanner optics so that imaging through the microscope slide occurs.

The focusing mechanism may comprise an auto-focus mechanism. Preferably, the focusing mechanism comprises an auto-focus mechanism as described in United Kingdom Patent Application No. 0618131.7 which is herein incorporated by reference. In particular, the auto-focus mechanism may comprise: an image sensor; a first source of radiation arranged to direct a first radiation beam such that the first radiation beam passes through the objective lens, strikes the test surface at a first position, reflects off the test surface and then strikes the image sensor; a second source of radiation arranged to direct a second radiation beam such that the second radiation beam passes though the objective lens, strikes the test surface at a second position, reflects off the test surface and then strikes the image sensor; a first processor for calculating the distance between the reflected first and second radiation beams striking the image sensor; a second processor for calculating the distance between the test surface and the focal plane of the optical system by converting the calculated distance between the reflected first and second radiation beams striking the image sensor into a distance between a fixed arbitrary reference plane crossing the optical axis and the test surface; and a transporter for moving at least one of the objective lens and the test surface relative to the other of the objective lens and the test surface, along the optical axis so that the part of the test surface that lies within the field of view of the objective lens coincides with the focal plane of the objective lens. The arbitrary reference point may correspond to the focal plane of the optical system.

When the sample exhibits a flat surface, for example, a microarray with a microscope slide as its solid support, the speed of the focusing may further be improved by use of a predictive focusing method. With such a method, the distance correction between the microscope objective and the test surface that is necessary due to re-positioning of the sample may be derived from previous corrective requirements. When this focusing correction is applied while the sample is moving, the subsequent autofocus operation may need to apply a smaller correction, thus making it faster and more precise.

The light source is preferably one or more lasers, for example a diode laser, a diode-pumped solid-state laser (DPSS), or a gas laser such as an Ar ion laser, an Ar/Kr ion laser or a Kr laser. Preferably, the light source emits light in the visible or near infra-red regions of the electromagnetic spectrum. Dye molecules can be thought of, in many cases, as having the properties of dipole moments. Electromagnetic radiation is thus absorbed with a polarisation anisotropy. Laser emission is typically linearly polarised, and the extinction ratio is typically on the order of 100:1. In many cases, this is due to the design of the laser cavity, which may include crystals and windows placed in the Brewster angle, leading to the selection of a preferred polarisation due to different intra-cavity losses for the two linear polarisations. When using laser light for the excitation of dye molecules with the aim to image substantially all fluorescent molecules, it is thus preferable to use unpolarised laser beams, for example, by combining two orthogonally polarised laser beams, for example, by using a polarising beam splitter. In some cases it is preferable to use circularly polarised light, radially polarised light, or azimuthally polarised light.

The illumination of the sample area being imaged onto the detector is preferably substantially homogenous. Preferably, the photon flux per unit area of the sample area being imaged onto the detector is substantially constant. This may be achieved by the use of a beam-shaping module for shaping the laser beam into a flat-top square beam which is then made divergent using a defocusing lens or combination of lenses. For example, two orthogonal cylindrical lenses with different focal lengths could be used to make a square beam rectangular in order to match it to a rectangular CCD. The illumination may be confined to the area that is being imaged onto the detector. If adjacent areas are illuminated as well undesirable photo-bleaching could result. By confining the illumination to the area that is being imaged onto the detector, such undesirable photo-bleaching is avoided. The beam shaping module may be based on a diffractive optical element, or alternatively on refractive optics (see also: Laser Beam Shaping: theory and techniques; Dickey & Holswade 2000). Preferably the output of the laser is directly controlled by signals received from the control unit of the detector of the fluorescent emission. Alternatively, a shutter mechanism such as an electro-mechanical shutter, an electro-optical shutter, or an acousto-optical shutter can be used to control the laser beam.

The signal level, S, on the detector depends on the illumination time, t, and the emission, E, of the sample. For a linear detector the equation is S=E·t. In a first embodiment, the illumination time, t, can be kept constant and thus the signal is proportional to the emission. From the signal level, consequently, the emission of the sample (and thus the number of fluorescent molecules) can be evaluated. Alternatively, in a second embodiment, the illumination time could be varied and the user could look instead, for example, for the signal to cross a threshold and evaluate the illumination time. This could be useful, for example, if the signal would ordinarily saturate the detector. This technology could be used for area detectors (i.e., one threshold for the entire CCD), for example, with Opteon's through the lens (TTL) triggering technique. The detector could be used to evaluate such a condition on a per-pixel basis.

Preferably the optical element for separating the excitation beam from the fluorescent emission from the sample comprises one or more filters and/or dichroic beamsplitters. Preferably, the extinction of the excitation light is such that substantially no excitation light reaches the detector. This may be achieved using dichroic beamsplitters in combination with a Raman filter.

The control unit is preferably configured to allow the parallel execution of several tasks. More preferably, the control unit is configured according to the scheduling mechanism discussed above and described in United Kingdom Patent Application No. 0618133.3 which is herein incorporated by reference.

The control unit may further perform either a subset, or a superset, of the following functions:
send commands and data to a detection unit,
receive data from the detection unit,
send commands to the translation stage,
receive data (e.g., position information) from the translation stage,
send commands to the auto focus mechanism, or control all or some of its components by receiving data, processing data, and sending commands to its components,
write data to non-volatile storage units (e.g., a magnetic hard disk)
process data, e.g., images,
combine images from different locations,
produce a thumbnail of the combination of all, or some of, the acquired images.

The scanner may further comprise a storage unit configured to store the data obtained by the control unit in a non-volatile memory such as a magnetic disk drive or a removable hard drive. Preferably the storage unit has a capacity of at least 100 MB, more preferably at least 1 GB, more preferably at least 120 GB and even more preferably at least 500 GB. In one embodiment, the result of a 25 mm² (e.g., (5 mm)²) patch can be stored on a recordable digital video disc (e.g., DVD-R, DVD+R, DVD-RW, DVD+RW, or similar).

The scanner is preferably implemented for single-colour use such that there is a single excitation wavelength band and the detector is configured to detect the wavelength band associated with the emission of a single fluorescent species. Radiation in a single excitation wavelength band could be provided by a light source in combination with a wavelength selector. The wavelength selector could be, for example, a filter, a filter set, an acousto-optical modulator, a combination of prisms, a combination of diffractive optical elements, a combination of gratings, etc. However, the scanner could be implemented with a multi-colour, for example dual-colour, 4-colour or 6-colour, setup for imaging two-colour samples, for example microarrays, where a comparison of two different samples is multiplexed into the optical colour space, or multi-colour enhanced sample, for example microarrays, where the target molecules or alternatively the probe-target complexes have been co-labelled with more than one colour fluorescent dye molecule (possibly through the use of intercalating dyes). The latter configuration could be used for more efficient background rejection, such as non-specific binding events of probe molecules to the surface, or contaminating fluorescence, or non-specific binding of free fluorescent tags, labels, dust or other particulate contamination.

The scanner may be configured to function at two or more different spatial resolutions: a first, lower resolution useful for finding an area of interest quickly, and a second, higher resolution useful for performing an optimum resolution scan that takes longer. This configuration allows more meaningful data to be captured, cutting down on possibly unnecessary scan area. Such a configuration also helps to reduce disk space, time spent on analysis, and time spent on the scan.

The present invention also provides a method for imaging single molecules, comprising:
providing a scanner according to the present invention;
holding a sample on the optical axis of the scanner;
positioning the sample in the focal plane of the scanner;
emitting an excitation beam and exciting one or more constituents of the sample to emit a fluorescent emission;
separating the excitation beam from the fluorescent emission from the sample;
detecting the fluorescent emission from the sample; and
using a control unit to control one or more elements of the detector, the focusing mechanism, and the light source.

General

The term “comprising” encompasses “including” as well as “consisting” e.g. a composition “comprising” X may consist exclusively of X or may include something additional e.g. X+Y.

The term “about” in relation to a numerical value x means, for example, x±10%. Where necessary, the term “about” can be omitted.

The word “substantially” does not exclude “completely” e.g. a composition which is “substantially free” from Y may be completely free from Y. Where necessary, the word “substantially” may be omitted from the definition of the invention.

### BRIEF DESCRIPTION OF THE DRAWINGS

FIG. 1 shows the components of a single molecule scanner according to the present invention.

FIG. 2 shows an exemplary optical path of a scanner according to the present invention.

FIG. 3 shows an exemplary optical path of an auto focus mechanism for use with the scanner according to the present invention.

FIG. 4 shows an exemplary optical path of a portion of a scanner according to the present invention.

FIG. 5 shows an exemplary optical path of a scanner according to the present invention.

FIG. 6 shows an exemplary optical path of an excitation beam mechanism for use with the scanner according to the present invention.

FIG. 7 shows an exemplary optical path of filtering apparatus for use with the scanner according to the present invention.

FIG. 8 shows an exemplary beam intensity profile of a square flat top excitation beam.

FIG. 9 shows a sample mounting platform for use with a single molecule scanner according to an embodiment of the present invention.

FIG. 10 shows two fractions of image captures at a single horizontal sample position, taken using a single molecule scanner according to an embodiment of the present invention. The left hand image shows a fraction of an image capture focused once before the image series was taken. The right hand image shows photo bleaching of dye molecules after 100 images were collected using a single molecule scanner according to an embodiment of the present invention.

FIG. 11 shows a time trace of the intensity values on several arbitrarily selected positions on the images of FIG. 10.

FIG. 12 shows images taken using a conventional scanner with a 5 μm spatial resolution.

FIG. 13 shows images taken using a single molecule scanner according to an embodiment of the present invention with a 130 nm spatial resolution.

### MODES FOR CARRYING OUT THE INVENTION

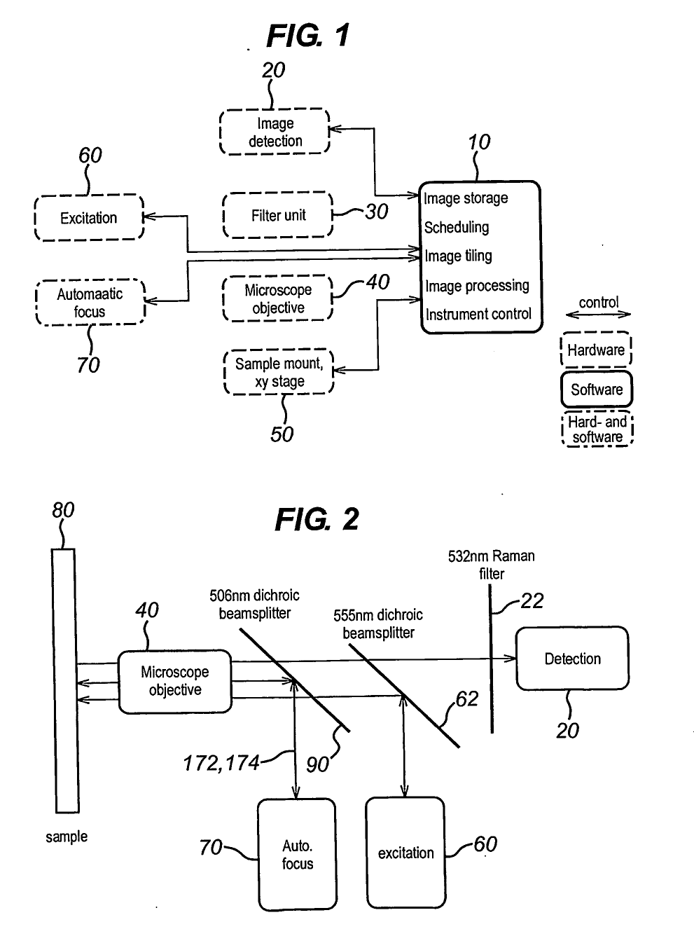

FIG. 1 shows the components of a single molecule scanner according to an embodiment of the present invention. In particular, the single molecule scanner of FIG. 1 includes software 10 for image storage, scheduling, image tiling, image processing, and instrument control, an image detection unit 20, a filter unit 30, a dry microscope objective 40, a sample positioning unit 50, excitation components 60, and an auto-focus mechanism 70. The image detection unit 20, the sample positioning unit 50, the excitation components 60 and the auto-focus mechanism 70 are controlled by software 10. Operation of the software 10 for image scheduling is described in co-pending United Kingdom patent application no. GB-0618133.3 which is hereby incorporated by reference. The scanner further comprises a storage unit configured to store the data obtained by the control unit in a non-volatile memory such as a magnetic disk drive.

As can be seen from FIG. 2, the auto-focus mechanism 70 uses a separate beam path from the fluorescence excitation and detection units 60, 20 of the scanner. In addition, the auto-focus, excitation and detection units all use radiation of different wavelength. All three beam paths pass through the same dry microscope objective 40 before striking the sample positioned at the surface of the microscope slide 80. The sample comprises a fluorescently labelled microarray which is not covered by a cover slip. The fluorescently labelled microarray could include fluorescent molecules dyed with Cy3 dye molecules linked to biopolymers, quantum dot labels or intercalating dyes. The dry microscope objective has a numerical aperture exceeding a value of 0.4. In particular, the microscope objection has an NA of 0.95 and a magnification of 50×.

The numerical aperture of the microscope objective has several effects on the system as a whole. Firstly, the NA determines the diffraction limit of the system, and can thus be used to determine the best magnification in combination with the pixel resolution of the detection unit. Secondly, the NA determines the light collection efficiency η, wherein

$$η = \frac{1}{2} \cdot ( 1 - cos ( {sin}^{- 1} ( NA ) ) ) .$$

This expression is valid for dry (i.e., non-immersion type) optics and yields collection efficiencies of 34% for NA=0.95 and 20% for NA=0.8, respectively. The decision of what level of light collection efficiency is sufficient depends on choices of the dyes, the light source, the noise level of the detection system, etc. In some cases the highest possible NA will be necessary, while in other cases (e.g., when biomolecules are labelled with more than one fluorescent label) a lower NA may be sufficient.

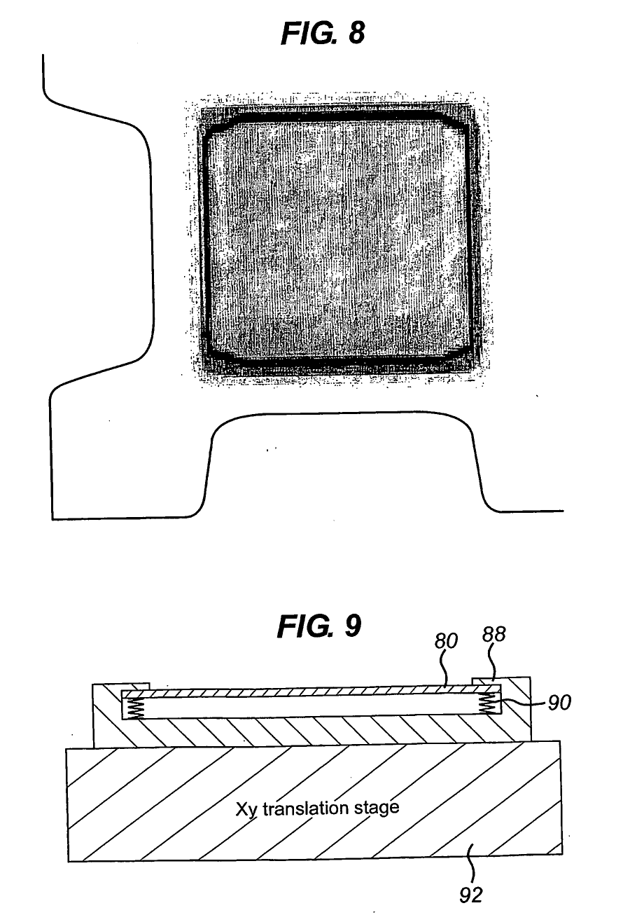

The beam used for excitation purposes is generated by two frequency-doubled, diode-pumped continuous-wave (cw) Nd:YAG excitation lasers 64, 65. Alternatively, diode lasers, other diode-pumped solid-state lasers, or gas lasers such as an Ar ion laser, an Ar/Kr ion laser or a Kr laser could be used. The two lasers have identical wavelengths. Since the lasers have a polarised output beam and the dye molecules act as a dipole, two laser beams with substantially orthogonal polarisation are combined into one beam, which is then used to ensure that substantially all dye molecules on the microarray capable of absorbing the excitation wavelength are excited. The beam steering tower of one of the excitation lasers has a particular arrangement of mirrors which changes the polarisation of the laser from p to s, or vice versa. The two excitation laser beams are combined using polarising beam splitter cube 66, and nearly 100% of the power in the individual laser beams is coupled into the combined beam. A beam shaping module based on a diffractive optical element (DOE) 67 shapes the combined excitation beam to have a square flat top intensity profile as shown in FIG. 8 so that the beam is substantially non-divergent. The combined excitation beam passes through lens 68 which has a focal length chosen so that the illumination of the sample area being imaged onto the detector in the field of view is full and substantially homogenous. The combined excitation beam is reflected by a 555 nm dichroic beamsplitter 62 and passes straight through a 506 nm dichroic beamsplitter 90 before striking the sample 80. The beam emitted by the fluorescing dyes then passes straight through the 506 nm dichroic beamsplitter 90 and the 555 nm dichroic beamsplitter 62, is filtered by a 532 nm Raman filter 22 to prevent any remnants of the excitation and auto focus beams from reaching the detection unit 20, and is detected by detection unit 20. In combination with a tube lens, the microscope objective provides a magnification of the sample onto the fluorescence detection unit 20.

The laser output is controlled, via electrical signals (TTL pulses), by the fluorescence detection unit 20, which is in turn controlled by the control unit 10. Alternatively, a shutter mechanism such as an electromechanical shutter, an electro-optical shutter or an acousto-optical shutter can be used to control the laser beam.

The fluorescence detection unit 20 includes a detector having a plurality of pixel elements. The linear dimension of each pixel element divided by the magnification of the microscope objective is smaller than the diffraction limited resolution of the microscope objective for visible light. The dark count and the noise level for selected exposure details of the detector are such that the emission of single or few fluorescent molecules or particles can be distinguished from the background and the noise. The detector is a CCD and is preferably a cooled CCD such as a peltier-cooled CCD. Alternatively, the detector could comprise a CMOS detector, an electron-multiplying CCD or an intensified CCD. In an exemplary embodiment, the detector comprises a Photometrics CoolSnapHQ detector which is cooled to −30° C. and has 1392×1040 pixels.

A suitable microscope slide holder is shown in FIG. 9. The sample on the microscope slide 80 is not covered by a cover slip and is pushed against a reference plate 88 by springs 90. The reference plate 88 is fixed relative to a translation stage unit 92. Therefore, thickness variations of the microscope slide do not affect the sample position relative to the microscope optics to the same extent as if the slide was positioned directly on the stage. Wedging of the slide is also not a problem, because only front-surface properties are relevant with this type of slide holder.

The translation stage unit 92 is movable in at least two directions which are substantially perpendicular to the optical axis of the microscope objective. The translation stage can be moved with a speed such that a scheduling mechanism as described in co-pending United Kingdom patent application no. 0618133.3 can be implemented. The translation stage unit 92 includes tilt-adjustment in order to position the sample substantially perpendicular to the optical axis. The translation stage is also moveable in a direction parallel to the optical axis. Preferably the travel range of the translation stage in the direction parallel to the optical axis is 400 μm. The translation stage unit 92 provides position information to the control unit 10 with a resolution comparable to or better than the linear pixel dimension of the detector divided by the magnification of the microscope objective. An exemplary embodiment uses a PIFOC translation stage in combination with micropositioning stages M-663 and M-665, all of which are manufactured by Physik Instrumente (PI).

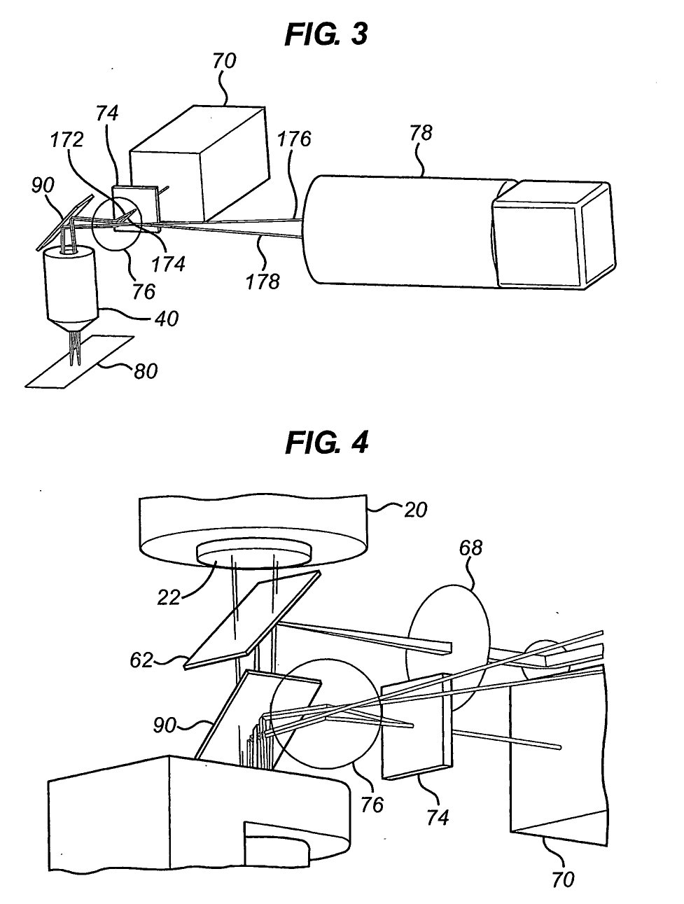

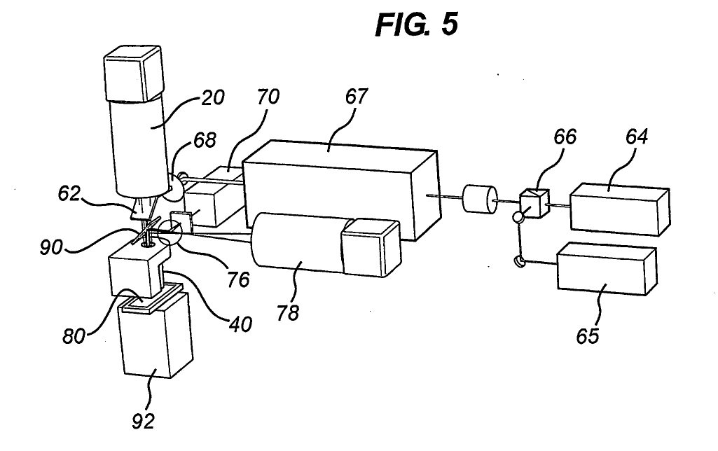

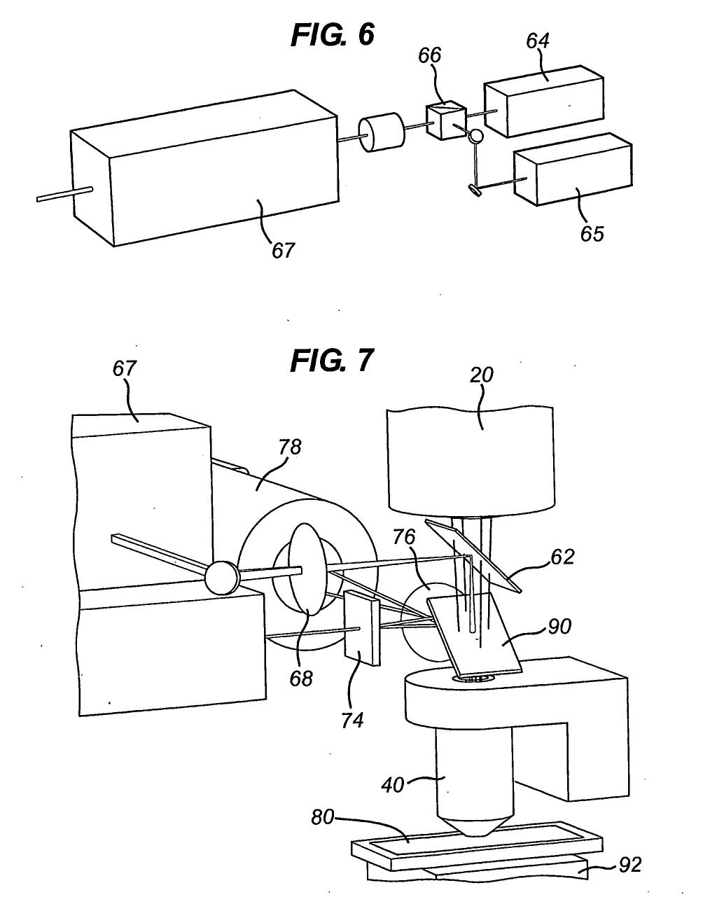

As can be seen from FIG. 3, the two light beams 172, 174 used for auto-focus purposes are generated by splitting one laser beam 170 into a large number of beams using a transmission grating 74. The beams 172, 174 used for auto-focus purposes are reflected off the 506 nm dichroic beamsplitter 90 before being projected onto the microscope slide 80. The laser beams 172, 174 are reflected off the microscope slide 80. The reflected auto-focus beams have the same wavelength as the original auto-focus beams and are also reflected by the 506 nm dichroic beamsplitter 90 before being imaged onto a particularly fast CCD camera 78 (e.g., full frame transfer time 8 ms) in the auto-focus unit 70. CCD camera 78 is separate from the CCD camera used for fluorescence detection in detection unit 20. A pellicle beam splitter 76 with 50% transmission and 50% reflection is used to separate the incoming beams 172, 174 from the outgoing beams 176, 178 without creating detectable ghost beams. Operation of the auto-focus mechanism 70 is described in co-pending United Kingdom patent application no. 0618131.7 which is herein incorporated by reference.

Control unit 10 is configured to control the detector, the auto-focus system, the light source and the translation stage and is configured to allow parallel execution of several threads, according to the scheduling mechanism described in co-pending United Kingdom patent application no. 0618133.3. The scanner also includes a storage unit configured to store the data obtained by the control unit in a removable hard drive capable of storing more than 1 GB of data.

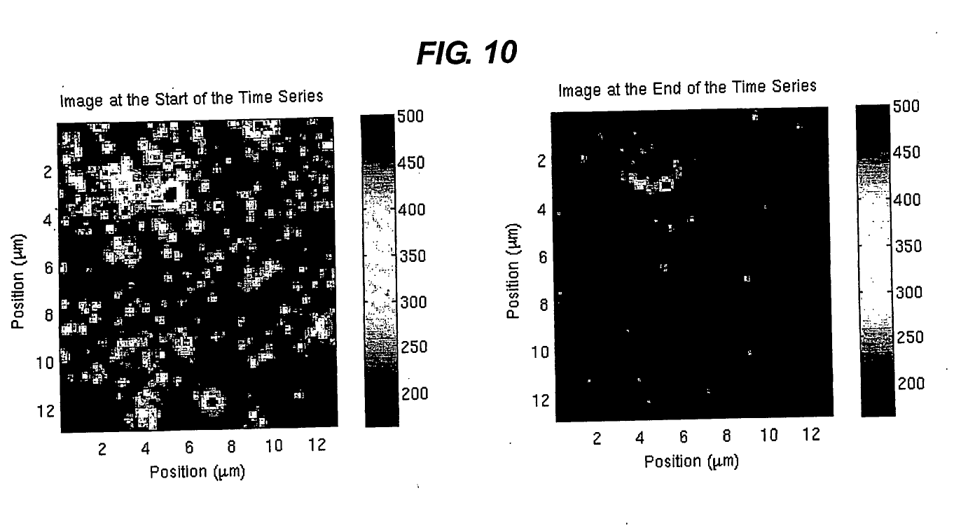

FIGS. 10 to 13 show experimental results of an exemplary embodiment of the present invention.

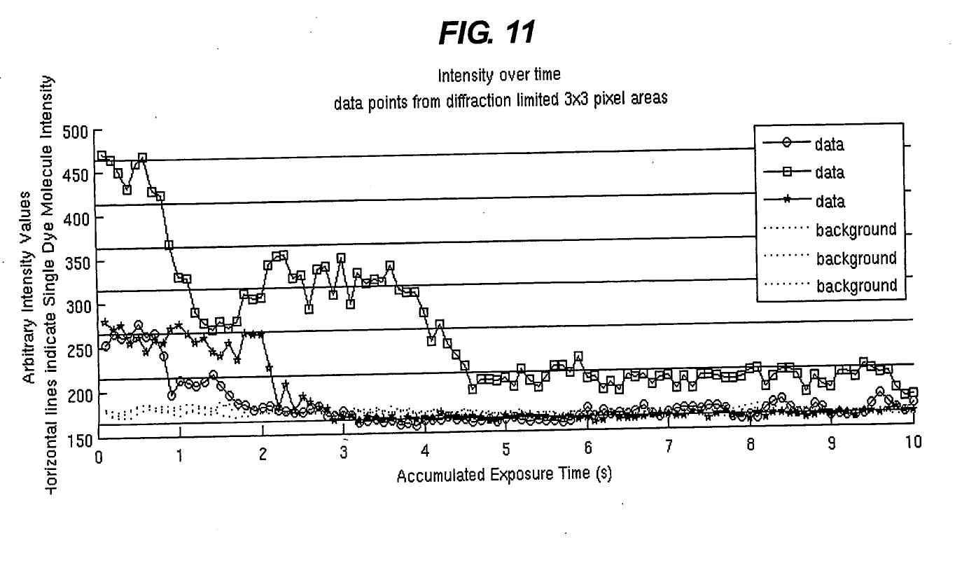

Using the Single Molecule Scanner of the present invention, the applicant has measured the emission from single dye molecules. This is evidenced by FIGS. 10 and 11. The left hand side of FIG. 10 shows a fraction of an image capture at a single horizontal sample position, focused once before the image series was taken.

The right hand side of FIG. 10 shows that after 100 images were collected using 100 ms exposure time each at maximum laser power, photo bleaching of dye molecules occurs. FIG. 11 shows a time trace of the intensity values on several arbitrarily selected positions on the image. This shows that the bleaching does not occur in smooth, analogue transitions, but that there is a quantised step whenever a dye molecule is bleached, or when one is turned back on (blinking). The digital levels of the scanner are indicated by the horizontal lines in FIG. 11.

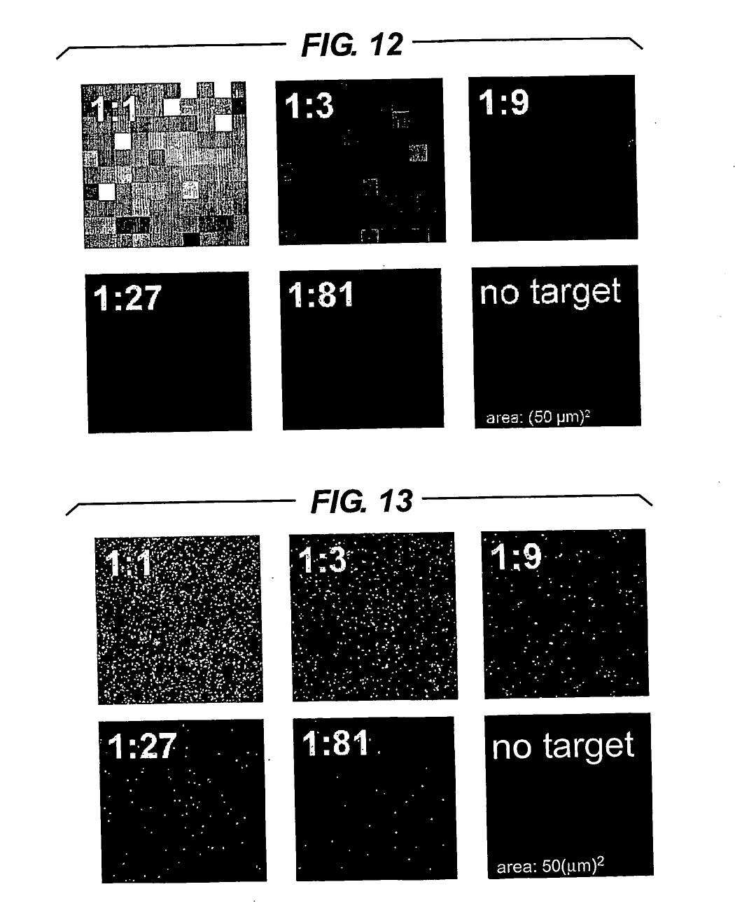

FIGS. 12 and 13 show that a scanner with a spatial resolution better than the diffraction limit allows more information to be extracted from a similar dilution series experiment than a conventional scanner with 5 μm spatial resolution. In particular, the electronic noise in a conventional scanner limits the sensitivity of the detection of low concentrations of fluorescent molecules. This is because there is no way to distinguish between signal and noise in this case. On the other hand, when the pixel resolution is better than the diffraction limit of the optical system, then signals stand out compared to noise by virtue of the spatial correlation (dots rather than drizzle). Consequently, single molecules can be distinguished from the noise, and even true “zero” results can be obtained. FIG. 12 shows the results of a conventional scanner with a 5 μm spatial resolution, and FIG. 13 shows the results of the single molecule scanner of the present invention with a 130 nm spatial resolution.

Therefore, it is clear that the applicant has developed an improved single molecule scanner. It will be clear to the man skilled in the art that the present invention has been described by way of example only, and that modifications of detail can be made within the spirit and scope of the invention.

1. A scanner for imaging single molecules and having a magnification, comprising:
a dry microscope objective defining an optical axis and having a numerical aperture of greater than or equal to 0.4.

2. A scanner according to claim 1, further comprising:
a sample holder for holding a sample on the optical axis;
a focusing mechanism for adjusting the relative position of the sample and an optical plane of the scanner so that the sample is positioned in the focal plane of the scanner;
a light source for emitting an excitation beam and exciting one or more constituents of the sample to emit a fluorescent emission;
an optical element for separating the excitation beam from fluorescent emission from the sample;
a detector for detecting the fluorescent emission from the sample, and having a plurality of pixel elements, wherein the linear dimension of each pixel element divided by the magnification of the scanner is smaller than the diffraction limited resolution of the microscope objective for visible light; and
a control unit configured to control one or more elements of the detector, the focusing mechanism, and the light source.

3. The scanner of claim 2 wherein the sample is a fluorescently labelled microarray.

4. The scanner of claim 2 wherein the sample is a bioanalysis sample.

5. The scanner of claim 3 wherein the sample contains fluorescent molecules or particles.

6. The scanner of claim 5, wherein the fluorescent molecules or particles comprise one or more of organic dyes, inorganic dyes, intercalating dyes, or modified fluorescent particles.

7. The scanner of claim 1 the microscope objective has a numerical aperture of greater than 0.6.

8. The scanner of claim 1 wherein the microscope objective has a numerical aperture of greater than 0.8.

9. The scanner of claim 1 wherein the microscope objective has a numerical aperture of greater than 0.6 but less than 1.

10. The scanner of claim 1 wherein the microscope optics is infinity-corrected optics comprising a first objective lens and a tube lens.

11. The scanner of claim 10 wherein the magnification of the scanner is provided by the first objective lens in combination with the tube lens.

12. The scanner of claim 1 wherein the microscope optics is a non-infinity-corrected microscope objective lens comprising a first objective lens.

13. The scanner of claim 1 wherein the lateral magnification, M, of the microscope optics is chosen to satisfy the equation
$$\frac{L}{M} < β \frac{α . λ}{NA} .$$
where L is the physical pixel size of a detector element in a linear dimension, α=0.61 for the Rayleigh criterion or α=0.47 for the Sparrow criterion, λ is the wavelength of light, NA is the numerical aperture of the optics, and β, is chosen to be 0.1<β<1.

14. The scanner of claim 2 wherein the detector comprises a CCD, a cooled CCD, a peltier-cooled CCD, a CMOS detector, an electron-multiplying CCD or an intensified CCD.

15. The scanner of claim 2 wherein the dark count and the noise level for selected exposure details of the detector are such that the emission from at least one fluorescent molecule or particle can be distinguished from a background.

16. The scanner of claim 2 and further comprising a translation stage moveable in at least two directions which are in a plane substantially perpendicular to the optical axis, wherein the sample holder is mounted on the translation stage.

17. The scanner of claim 16 wherein the translation stage is provided with tilt-adjustment for positioning the portion of the sample in the field of view of the scanner in a plane substantially perpendicular to the optical axis.

18. The scanner of claim 16 wherein the translation stage is movable in a direction substantially parallel to the optical axis.

19. The scanner of claim 1 wherein the objective lens is movable in a direction substantially parallel to the optical axis.

20. The scanner of claim 16 wherein the control unit is configured to control the translation stage and the translation stage provides position information to the control unit.

21. The scanner of claim 20 wherein the position information has a resolution comparable or better than the linear pixel dimension of the detector divided by the magnification of the microscope objective.

22. The scanner of claim 2 wherein the sample holder provides a reference surface against which a test surface that is to be imaged is pressed.

23. The scanner of claim 2 wherein the light source comprises at least one laser, diode laser, diode-pumped solid-state laser (DPSS), or gas laser.

24. The scanner of claim 2 wherein the photon flux per unit area of the sample area being imaged onto the detector is substantially constant.

25. The scanner of claim 24 wherein the illumination is confined to the sample area being imaged onto the detector.

26. The scanner of claim 24, further comprising a beam-shaping module for shaping the laser beam into a flat-top square beam.

27. The scanner of claim 26, further comprising a defocusing lens.

28. The scanner of claim 23 wherein the laser emission is controlled by signals received by the control unit from the detector of the fluorescent emission.

29. The scanner of claim 23 further comprising a shutter mechanism for controlling the laser beam.

30. The scanner of claim 29 wherein the shutter mechanism comprises an electro-mechanical shutter, an electro-optical shutter, or an acousto-optical shutter.

31. The scanner of claim 2 wherein the optical element for separating the excitation beam from the fluorescent emission from the sample comprises one or more filters and/or dichroic beamsplitters.

32. The scanner of claim 2 wherein the control unit is configured to allow the parallel execution of several tasks.

33. The scanner of claim 2, further comprising a storage unit configured to store the data obtained by the control unit in a non-volatile memory.

34. The scanner of claim 2, wherein the light source provides light of a single excitation wavelength band and the detector is configured to detect the wavelength band associated with the emission of a single fluorescent species.

35. The scanner of claim 2, wherein the light source in combination with a wavelength selector provides light of a single excitation wavelength band and the detector is configured to detect the wavelength band associated with the emission of a single fluorescent species.

36. The scanner of claim 2 wherein the light source emits light of multiple excitation wavelengths and the detector is configured to detect multiple wavelength bands associated with the emission from multiple fluorescent species.

37. A method for imaging single molecules, comprising:
providing a scanner according to claim 1,
holding a sample on the optical axis of the scanner;
positioning the sample in the focal plane of the scanner;
emitting an excitation beam and exciting one or more constituents of the sample to emit a fluorescent emission;
separating the excitation beam from the fluorescent emission from the sample;
detecting the fluorescent emission from the sample; and
using a control unit to control one or more elements of the detector, the focusing mechanism, and the light source.
